(19) United States
(12) Patent Application Publication
(10) Pub. No.: US 2007/0288619 A1
(43) Pub. Date: Dec. 13, 2007

(54) Terminal Apparatus For Wireless Connection And A Wireless Connection Administration Method Using The Same

(76) Inventors: Sun-Mi Jun, Daejeon-city (KR); Nam-Hoon Park, Daejeon-city (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/661,171

(22) PCT Filed: Aug. 25, 2005
(86) PCT No.: PCT/KR05/02806

§ 371 Date: Feb. 26, 2007

(30) Foreign Application Priority Data
Aug. 25, 2004 (KR) 10-2004-0067106

(51) Int. Cl. H04L 29/08

(52) U.S. Cl. 709/223

(57) ABSTRACT

A wireless connection terminal unit is controlled to download a web page in portable Internet, the control apparatus including a HTTP packet analyzer for analyzing a starting a HTTP packet and a HTTP session management unit including a HTTP packet transmitting/receiving information table at which HTTP request packet information is recorded. The HTTP session management unit controls a HTTP session unit according to characteristics of a web page to be down-loaded such that resource maintenance can be efficiently performed and competition for establishing connection and time for downloading a web page can be reduced.

### TECHNICAL FIELD

The present invention relates to a wireless connection terminal apparatus for downloading a web page in portable Internet and a wireless connection management method.

### BACKGROUND ART

Generally, a server forms a basic structure for performing a response (HTTP response) for a client request. Accordingly, the server transmits the web document through a HTTP protocol when the client requests a web document on the Internet (HTTP request).

The HTTP protocol is a protocol where a session is not maintained. Thus, only when one HTTP response message is received for one HTTP request message, a TCP session is maintained. In detail, when a client downloads any web document, for example, ‘The Project.html’ document, including image, sound, and flash files, to express the same through a screen, for each of the subordinate contents (image, sound, and flash files), as well as an html source, that is downloaded, a HTTP request/response processing should be achieved. As a result, the TCP connection must be repeatedly opened and closed between the client and the server. For example, during downloading the web document through the HTTP protocol, independent TCP connections are required to be opened for the respective subordinate contents. This process for opening a TCP connection is repeatedly performed whenever files of the contents belonging to the one web document are acquired and presented.

However, the conventional wireless Internet environment requires a further connection of the lower layer as well as the TCP connection. That is, in order to establish and cancel the TCP connection, a wireless connection should also be established and cancelled.

For example, when the wireless Internet environment includes three other contents as well as the html source, as in the above ‘The Project.html’, in order to present the same in a terminal device, a TCP connection is opened and closed four times.

However, when a wireless network has a connection oriented MAC protocol, such as the GPRS, a further MAC connection of the lower layer is established and cancelled four times, as well as the four opening/closings of the TCP connection.

Accordingly, when the MAC connection is administrated without considering a HTTP service characteristic in the conventional wireless Internet service, there is a problem that a radio resource cannot be efficiently used.

That is, on determining a connection unit of the MAC layer for transmitting a general TCP/IP, the following two problems occur.

First, since a signal process is necessarily requested so as to establish and cancel the MAC connection in a wireless section, a repetition of functions for establishing and canceling the MAC connection causes a delay of QoS.

Second, when the MAC connection is maintained without using the radio resource in order to save a process cost for establishing and canceling the MAC connection, the usage rate of the radio resource is lowered and the radio resource is inefficiently managed.

In order to solve the two above-noted problems, an alternative connection administration method has been developed so as to efficiently use the radio resource of the connection oriented MAC as IEEE 802.16 series, considering an ultimate desired service characteristic.

Meanwhile, European patent No. 1148689 entitled “a method for downloading a web page” discloses that an idle resource so called a rendezvous is provided between a terminal device and a base station, such that the idle resource controls maintaining and closing a link, in order to download a web page in wireless communication. But, according to the prior art, an idle resource, so called a rendezvous should be set and for this rendezvous, an additional RLC message should be defined and an additional message interchanging process should be performed. Thus, the process is very complicated.

The above information disclosed in this Background section is only for enhancement of understanding of the background of the invention and therefore, it may contain information that does not form the prior art that is already known in this country to a person of ordinary skill in the art.

### DISCLOSURE OF INVENTION

### Technical Problem

The present invention has been made in an effort to provide a wireless connection terminal apparatus for downloading a web page having advantages of efficiently using a radio resource by efficiently performing an establishment/cancellation process of a MAC connection requested by all means in order to download a HTTP document and all the subordinate contents files when the HTTP protocol is operated in an upper layer.

### Technical Solution

A wireless connection terminal apparatus and a wireless connection management method for downloading a HTTP web page as a representative web service in portable Internet are provided.

An exemplary wireless connection terminal unit includes a HTTP packet analyzer for analyzing a HTTP packet, and a HTTP session management unit including a HTTP packet transmitting/receiving information table at which a HTTP request packet information is recorded, wherein the HTTP session management unit controls a HTTP session unit according to characteristics of a web page to be downloaded.

According to one exemplary embodiment of the present invention, a wireless communication terminal unit analyzes a HTTP packet of a desired web page to be downloaded, determines such characteristics as the number of the TCP connection establishment/cancellation processes for downloading all files desired to perfectly present the web page, and controls to maintain the HTTP session during the determined number of TCP connection establishment/cancellation processes.

In a further embodiment, a wireless connection administration method to control a HTTP session unit according to characteristics of a web page includes a) recording a start HTTP request packet information at a HTTP packet transmitting/receiving information table and transmitting the start HTTP request packet to a server, b) analyzing a HTTP response packet corresponding to the start HTTP request packet received from the server, writing out a HTTP request packet, recording the written HTTP request packet information at the HTTP packet transmitting/receiving information table, and transmitting the HTTP request packet to the server, c) comparing the received HTTP response packet with the HTTP request packet information HTTP recorded at the HTTP packet transmitting/receiving information table to check receipt of the HTTP response packet, and d) ending the wireless connection when the HTTP response packet has been received

### BRIEF DESCRIPTION OF THE DRAWINGS

FIG. 1 is a schematic view of a wireless communication terminal unit according to an exemplary embodiment of the present invention.

FIG. 2 is a schematic diagram of a HTTP packet analyzer according to an exemplary embodiment of the present invention.

FIG. 3 is an information table for transmitting/receiving a HTTP packet according to an exemplary embodiment of the present invention.

FIG. 4 is a flowchart of a wireless connection administration method according to an exemplary embodiment of the present invention.

FIG. 5 is a detailed flowchart illustrating a process from starting a wireless connection to transmitting a start HTTP request packet among a wireless connection administration method according to an exemplary embodiment of the present invention.

FIG. 6 is a detailed flowchart illustrating a process from receiving a HTTP response packet corresponding to a start HTTP request packet to transmitting a further start HTTP request packet among a wireless connection administration method according to an exemplary embodiment of the present invention.

FIG. 7 is a detailed flowchart illustrating a process from standing by a HTTP response packet to ending a wireless connection among a wireless connection administration method according to an exemplary embodiment of the present invention.

FIG. 8 is a flowchart illustrating a process from checking a received HTTP response packet to be a desired HTTP response packet among a wireless connection administration method of an exemplary embodiment of the present invention.

FIG. 9 is a schematic view of a wireless connection administration method of an exemplary embodiment of the present invention.

### BEST MODE FOR CARRYING OUT THE INVENTION

With reference to the accompanying drawings, the present invention will be described in order for those skilled in the art to be able to implement the invention. As those skilled in the art would realize, the described embodiments may be modified in various different ways, all without departing from the spirit or scope of the present invention. Accordingly, the drawings and description are to be regarded as illustrative in nature and not restrictive.

An embodiment of the present invention will hereinafter be described in detail with reference to the accompanying drawings.

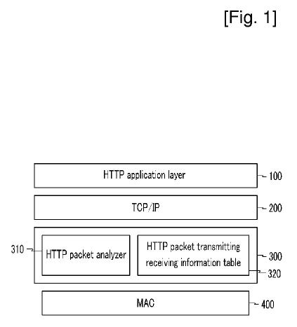

FIG. 1 is a schematic view of a wireless communication terminal unit according to an exemplary embodiment of the present invention.

As shown in FIG. 1, a wireless communication terminal unit includes a HTTP application layer 100, a TCP/IP 200, a HTTP session management unit 300, and a MAC layer 400.

The HTTP session management unit 300 includes a HTTP packet analyzer 310 and a HTTP packet transmitting/receiving information table 320.

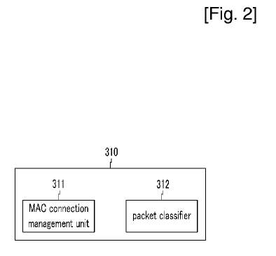

FIG. 2 is a schematic diagram of a HTTP packet analyzer according to an exemplary embodiment of the present invention. As shown in FIG. 2, the HTTP packet analyzer 310 includes a MAC connection management unit 311 and a packet classifier 312.

The MAC connection management unit 311 controls a connection of the MAC layer 400 and the packet classifier 312 analyzes a HTTP packet and determines the desired number of processes for establishing and closing a TCP connection so as to present a web page.

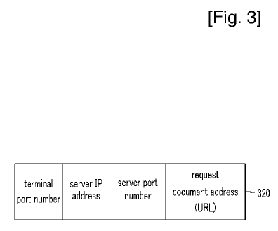

FIG. 3 is a schematic diagram of a HTTP packet transmitting/receiving information table according to an exemplary embodiment of the present invention. As shown in FIG. 3, the HTTP packet transmitting/receiving information table 320 includes a terminal port number, a server IP address, a server port number, and a request document address (URL).

The HTTP session management unit 300 is installed at the terminal unit and analyzes a packet before transmitting the packet to an uplink considering HTTP/TCP characteristics and sets a logic session for downloading a web page, analyzes a server response packet provided through a downlink, and determines to maintain the session.

In this embodiment, a unit of the session maintenance is designed to present a one-unit web page in a user web browser, and to simultaneously download even subordinate files (image, multimedia, text etc.) as well as a user request document (html document) within the one-unit session.

The MAC connection is maintained until all files are downloaded. Such processes for establishing and closing the MAC connection are controlled by the respective terminal units. Accordingly, a process for maintaining and ending a session may also be determined by the respective terminal units.

In order to efficiently establish the MAC wireless connection for the HTTP service, the process for creating the MAC wireless connection is performed. When all files for presenting a desired web page are downloaded, in order to cancel the wireless connection, the process for closing the MAC wireless connection is performed. The HTTP session management unit 300 controls such processes for establishing and closing the MAC connection.

The HTTP session management unit 300 filters (analyzes) a HTTP packet of a desired web page to be downloaded, determines such characteristics as the number of TCP connection establishment/cancellation processes for downloading all files desired to perfectly present the web page, and controls to maintain the HTTP session during the determined number of TCP connection establishment/cancellation processes.

Thus, the HTTP session management unit principally serves to provide a logic session unit for no session HTTP protocols and establishes/cancels the wireless connection according to the session unit. That is, the HTTP session management unit determines an optimal session unit for efficiently downloading the HTTP web page considering traffic usage characteristics of the web user.

In this embodiment, the traffic characteristics of the web user are as follow.

Generally, the user should open a word file, an image file, and a flash file so as to download the desired web page and acquire the desired information. In order to present such a web page, the subordinate image file, flash file and multimedia files, as well as the URL file which the user requires to the web browser, should be transmitted. Accordingly, during downloading and seeing one web page, a possibility to require a download of another web page is remarkably reduced and also a radio resource is not used.

Accordingly, the optimal scale of the HTTP web page session is given as a session length for presenting the entire contents of one web page (all subordinate files as well as the request URL file) in a web browser of the user terminal unit.

The HTTP session management unit analyzes the HTTP request packet and the HTTP response packet by the HTTP packet analyzer. When the packet is the HTTP request packet, the HTTP session management unit records the packet information at the HTTP packet transmitting/receiving information table. When the packet is the HTTP response packet, the HTTP session management unit compares the packet with the recorded information of the HTTP packet transmitting/receiving information table, checks whether the packet is appropriate for presenting the desired web page and transmits the appropriate packet to the web browser.

Also, the HTTP session management unit analyzes the HTTP response packet corresponding to the HTTP request packet by the HTTP packet analyzer, writes out the HTTP request packet for all contents required to present the desired web page, and records the HTTP request packet at the HTTP packet transmitting/receiving information table. Accordingly, the terminal unit can check receipt of the HTTP response packet for all contents required to present the desired web page.

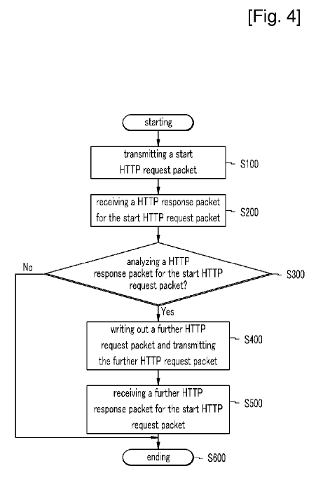

FIG. 4 is a flowchart of a wireless connection administration method of an exemplary embodiment of the present invention.

As shown in FIG. 4, in order to download a web page through a wireless system, a wireless connection administration method includes a) transmitting a start HTTP request packet to a server (S100), b) analyzing a HTTP response packet for the start HTTP request packet (S300), writing out a further HTTP request packet, and transmitting the further HTTP request packet to the server (S400), c) receiving a HTTP response packet for the further HTTP request packet (S500), and d) ending a wireless connection when all HTTP response packets are received (S600).

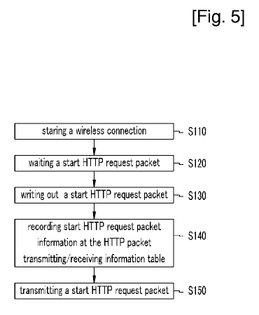

A wireless connection administration method of an exemplary embodiment of the present invention will be described in detail with reference to FIG. 5 to FIG. 8.

FIG. 5 is a detailed flowchart illustrating a process from starting a wireless connection to transmitting a start HTTP request packet in a wireless connection administration method of an exemplary embodiment of the present invention.

The HTTP session management unit knows a start of a HTTP session and establishes a MAC wireless connection. A first TCP:SYN packet is transmitted from an IP layer of the terminal unit to an inputted new address thereby generating a wireless connection MAC (S110), and then a HTTP request packet of the desired web page is on stand by (S120). When the HTTP request packet is reached at a MAC layer, it is checked that the HTTP request packet has the same desired address field as the TCP:SYN and begins with GET/HTTP/version\r\n token. Thereafter, the MAC wireless connection is established, the TCP packet-HTTP request packet is transmitted to the base station (the server), and the MAC wireless connection is fixed to process the current HTTP session.

This MAC wireless connection is fixed until the HTTP session ends. In this case, the first HTTP request packet to start a session is called a start HTTP request packet and is classified with other HTTP request packets. In this embodiment, the start HTTP request is generally given as the html of the desired web page to be downloaded.

Thereafter, information for the start HTTP request packet is recorded at the HTTP packet transmitting/receiving information table (S140), the start HTTP request packet is transmitted (S150), and the HTTP response packet for the start HTTP request packet of the server is on stand by.

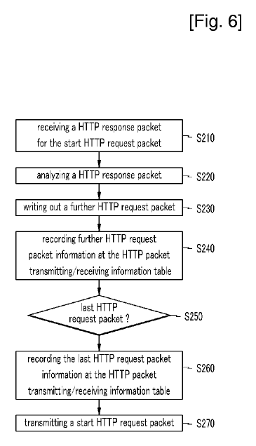

FIG. 6 is a detailed flowchart illustrating a process from receiving a HTTP response packet concerning a start HTTP request packet to transmitting an additional HTTP request packet in a wireless connection administration method of an exemplary embodiment of the present invention.

When the HTTP response packet is checked to correspond to the start HTTP request packet, the HTTP response packet is received and transmitted to the web browser of the application program (S210).

The web browser analyzes the HTTP response packet (S220) to present the analyzing result thereof. When the analyzing result requires further files (image, music, and flash files), the subordinate HTTP request packets of the current document are again written out (S230). These subordinate HTTP request packets are passed through the IP layer and connected with the wireless connection of the lower MAC layer which has been set and used more previously. Thereafter, the HTTP request packet is mapped, transmitted to the server, and queued.

At this time, the mapping information of the HTTP request packet is recorded at the HTTP packet transmitting/receiving information table (S240).

It is determined which is the last request packet among a series of subordinate HTTP request packets (S250). When all information of the HTTP request packet has been recorded at the HTTP packet transmitting/receiving information table, the HTTP request packet is mapped, loaded in the packet classifier, and transmitted to the server (S270) while the HTTP response packet for the HTTP request packet is standing by.

At the step S250, various references to determine the last request packet among a series of subordinate HTTP request packets may be applied within the sprit of the present invention.

In this embodiment, an average time which it takes for the continuous request packets to arrive is used as the reference to determine the last request packet among a series of subordinate HTTP request packets. In detail, when no request packet is further transmitted despite waiting for the predetermined time or longer, a directly previous HTTP request packet is determined to be the last HTTP request packet.

However, this is just one example and the reference to determine the last request packet can obviously be varied by a person skilled in the art within the sprit of the present invention.

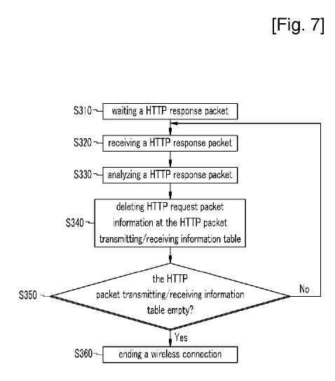

FIG. 7 is a detailed flowchart illustrating a process from standing by for a HTTP response packet to ending a wireless connection in a wireless connection administration method of an exemplary embodiment of the present invention.

As shown in FIG. 7, the HTTP response packet for the subordinate HTTP request packet is waited for (S310). When the HTTP response packet arrives at (S320), the HTTP response packet is analyzed and checked to be corresponding to the last HTTP request packet. When the HTTP response packet corresponds to the last HTTP request packet, the HTTP session is ended. When the HTTP response packet does not correspond to the last HTTP request packet, the steps S330 to S350 are repeated until the last response packet is received.

In this embodiment, the HTTP packet transmitting/receiving information table is used to check that the HTTP response packet corresponds to the last HTTP request packet.

The HTTP packet information recorded at the HTTP packet transmitting/receiving information table includes the terminal port number, the server IP address, the server port number, and the request document address shown in FIG. 3 FIG. 2 is, when the HTTP response packet is received, it is checked that the HTTP request packet information corresponding to the HTTP response packet information is found at the HTTP packet transmitting/receiving information table. When the HTTP request packet information is found at the HTTP packet transmitting/receiving information table, the corresponding record is deleted from the HTTP packet transmitting/receiving information table. Accordingly, when the HTTP response packet is received corresponding to the HTTP request packet, it is known that the HTTP packet transmitting/ receiving information table 320 becomes empty and all the desired files are downloaded. Continuously, when all the HTTP request packet information are deleted from the HTTP packet transmitting/receiving table such that the HTTP packet transmitting/receiving table becomes empty, the HTTP session ends (S350 and S360). In detail, the number of the HTTP request packet is compared with the number of the HTTP response packet. When the number of the HTTP request packet coincides with the number of the HTTP response packet, a scale of one page is determined to have been transmitted and a web page download session is established to be completed (S360).

According to one exemplary embodiment of the present invention, when the recorded information is deleted in the HTTP packet transmitting/receiving information table, it is checked that all the desired files have been downloaded. However, this is only one example and the method can obviously be varied by a person skilled in the art within the sprit of the present invention.

Meanwhile, when all the information of the desired web page is downloaded and a TCP connection cancellation instruction is provided, the TCP connection cancellation instruction is referred to as a MAC connection cancellation request 1008. Thus, the wireless connection (MAC) is canceled.

According to the exemplary embodiment of the present invention, the web page session is determined by the HTTP session from transmitting a HTTP request to completely receiving a HTTP response message corresponding to the HTTP request, and it is realized by the HTTP session management unit, which is capable of performing the MAC wireless connection establishing process and the MAC wireless connection canceling process.

According to the exemplary embodiment of the present invention, by using the HTTP session management unit, only files required to express the desired web page are transmitted, and the establishment and cancellation of the MAC connection is controlled according to the HTTP session. That is, according to the exemplary embodiment of the present invention, a completion of the HTTP session is determined by the terminal unit.

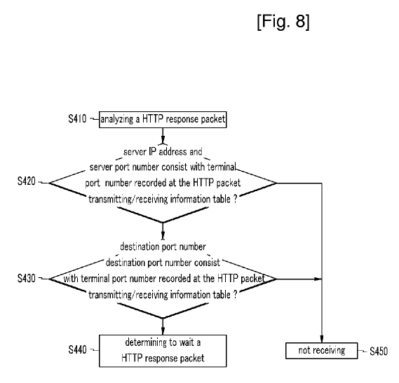

FIG. 8 is a flowchart illustrating a process from checking a received HTTP response packet to ending a wireless connection in a wireless connection administration method of an exemplary embodiment of the present invention.

In this embodiment, in order to check that the received HTTP response packet corresponds to the HTTP request packet, the received packet is analyzed to check that a source IP address and a port number agree with the server IP address and server IP port number recorded at the HTTP packet transmitting/receiving information table 320 (S420), and that a destination port number of the received packet agrees with the terminal port number recorded at the HTTP packet transmitting/receiving information table 320 (S430).

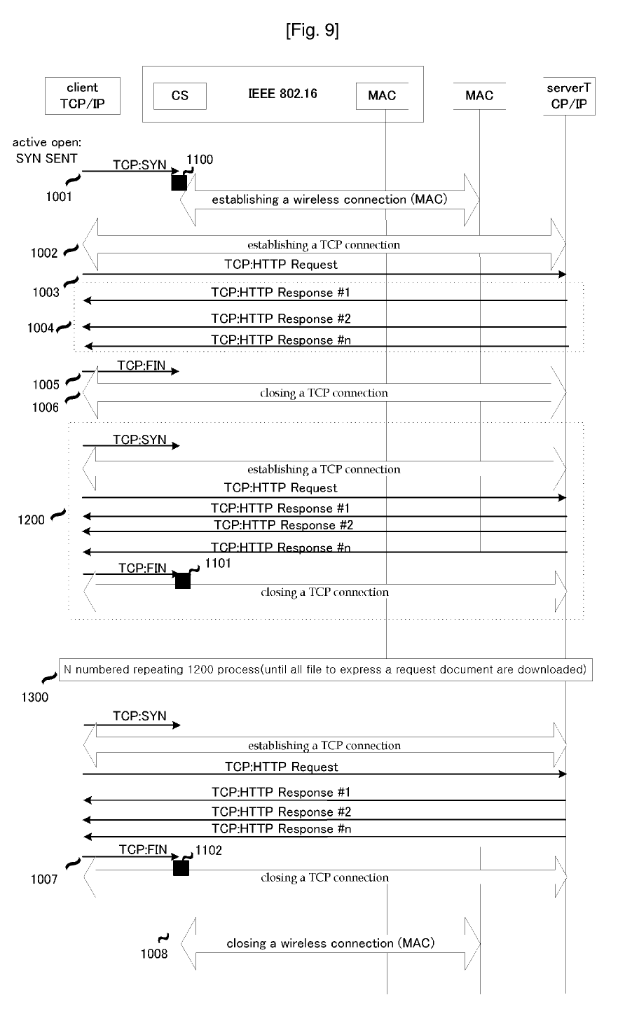

FIG. 9 is a schematic view of a wireless connection administration method of an exemplary embodiment of the present invention.

When a user requests a desired page to a web browser, the terminal unit transmits TCP:SYN to CS according to the inputted desired URL. As a result, the wireless connection (MAC) is generated to be established.

According to the exemplary embodiment of the present invention, one wireless connection is maintained during one session period, where the one session period is referred to as a period used to download all the subordinate contents (image, sound, flash files etc.) as well as a HTML of the desired web page. Although a connection cancellation introduction of the TCP layer is provided during respectively downloading all the subordinate contents (image, sound, flash files, etc.) as well as a HTML of the desired web page, the previously established MAC wireless connection is itself maintained.

According to the exemplary embodiment of the present invention, the HTTP session management unit checks to see if all files included in a desired web page have been downloaded. If so, the MAC wireless connection ends.

According to the exemplary embodiment of the present invention, when the HTTP web page is downloaded in a wireless packet system type portable Internet, resource maintenance of a wireless connection can be efficiently performed, and competition for establishing connection and time for downloading a web page can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A wireless connection terminal unit, comprising:
a HTTP packet analyzer for analyzing a HTTP packet; and
a HTTP session management unit including a HTTP packet transmitting/receiving information table at which HTTP request packet information is recorded,
wherein the HTTP session management unit controls a HTTP session according to characteristics of a web page to be downloaded.

2. The wireless connection terminal unit of claim 1, wherein:
the HTTP packet analyzer checks the number of TCP connection establishment and cancellation processes required to present a web page,
and the HTTP session management unit controls the wireless connection to be maintained during the number of TCP connection establishment and cancellation processes.

3. The wireless connection terminal unit of claim 1, wherein:
the HTTP packet analyzer includes a MAC connection management unit for controlling a wireless connection and a packet classifier for analyzing a HTTP packet.

4. The wireless connection terminal unit of claim 1, wherein:
the HTTP packet transmitting/receiving information table stores at least one of a HTTP request packet terminal port number, a server IP address, a server port number, and a request document address (URL).

5. A wireless connection administration method to control a HTTP session unit according to characteristics of a web page, the method comprising:
a) recording a start HTTP request packet information at a HTTP packet transmitting/receiving information table and transmitting the start HTTP request packet to a server;
b) analyzing a HTTP response packet for the start HTTP request packet received from the server, generating a HTTP request packet, recording the generated HTTP request packet information at the HTTP packet transmitting/receiving information table, and transmitting the HTTP request packet to the server;
c) comparing the received HTTP response packet with the HTTP request packet information HTTP recorded at the HTTP packet transmitting/receiving information table to check receipt of the HTTP response packet; and
d) ending the wireless connection when the HTTP response packet is received.

6. The wireless connection administration method of claim 5, wherein:
when the HTTP response packet for the HTTP request packet is received, comparing the received HTTP response packet information with the HTTP request packet information recorded at the HTTP packet transmitting/receiving information table to check whether the received packet is appropriate for presenting the desired web page, and transmitting the appropriate packet to a web browser.

7. The wireless connection administration method of claim 5, wherein:
at b), the directly previous HTTP request packet is determined to be the last HTTP request packet when there is no HTTP request packet transmitted to the HTTP packet transmitting/receiving information table after a predetermined time passes.

8. The wireless connection administration method of claim 5, wherein:
at c), when the HTTP response packet is received, the HTTP request packet information corresponding to the HTTP response packet information is deleted from the HTTP packet transmitting/receiving information table, and
when there is no further HTTP request packet information to be deleted from the HTTP packet transmitting/receiving information table, it is determined that the HTTP response packet has been received corresponding to the HTTP request packet.
